(19) United States
(12) Patent Application Publication
(10) Pub. No.: US 2022/0317913 A1
(43) Pub. Date: Oct. 6, 2022

(54) SYSTEMS AND METHODS OF ATTACHING DATA AND ITS LIFETIME TO A RELATIONSHIP BETWEEN ENTITES

(71) Applicant: Google LLC, Mountain View, CA (US)

(72) Inventor: Manish Thakore, Seattle, WA (US)

(21) Appl. No.: 17/218,537

(22) Filed: Mar. 31, 2021

(51) Int. Cl. G06F 3/06; H04L 9/08; G05B 19/042

(52) U.S. Cl. CPC G06F 3/0652; H04L 9/0861; G06F 3/0679; G06F 3/0604; G05B 19/042; G05B 2219/2642

(57) ABSTRACT

Implementations of the disclosed subject matter provide system and methods of receiving, at a server coupled to a home security system or smart home system, a notification setting for a user for a first entity representing a first home. The notification setting for the user for the first entity may be stored by generating a primary key prefix based on a relationship of the user to the first entity, and storing the notification setting for the user by associating the notification setting with the primary key prefix. The server may receive a request to delete the relationship to the first entity when the relationship between the user and the first home has ended. Data at the first entity associated with the relationship of the user to the first home may be automatically deleted based on the received request using the primary key prefix to find and remove the data.

### BACKGROUND

Presently, smart homes or home security systems store settings data in connection with a user device, with a device of a security system, or with the security system itself. Some current system use custom solutions or custom data types to store settings data. Such customs solutions typically include using data that maps to the user or the home entity. Any data cleanup required when a user's status with the home security system changes must be designed and implemented by a system manager, or performed manually.

### BRIEF SUMMARY

According to an implementation of the disclosed subject matter, a method may include receiving, at a server that is communicatively coupled to a home security system or smart home system of at least one home, a notification setting for a user for a first entity representing a first home of the at least one home. The method may include generating, at the server, a first label for the first home represented by the first entity, and storing, at a storage device communicatively coupled to the server, a relationship between the user and the first entity using the first label. The method may include storing, at the storage device, the notification setting for the user for the first entity by generating a primary key prefix based on a relationship of the user to the first entity, and storing the notification setting for the user by associating the notification setting with the primary key prefix. The server may receive a request to delete the relationship to the first entity when the relationship between the user and the first home has ended. The method may include automatically deleting, at the storage device communicatively coupled to the server, data at the first entity associated with the relationship of the user to the first home based on the received request using the primary key prefix to find and remove the data.

According to an implementation of the disclosed subject matter, a system may include a server having a hardware processor and a memory that is communicatively coupled to storage device and to a home security system or smart home system of at least one home that may receive a notification setting for a user for a first entity representing a first home of the at least one home. The server may generate a first label for the first home represented by the first entity, and store at the storage device, a relationship between the user and the first entity using the first label. The server may store, at the storage device, the notification setting for the user for the first entity by generating a primary key prefix based on a relationship of the user to the first entity, and storing the notification setting for the user by associating the notification setting with the primary key prefix. The server may receive a request to delete the relationship to the first entity when the relationship between the user and the first home has ended. The server may automatically delete, at the storage device, data at the first entity associated with the relationship of the user to the first home based on the received request using the primary key prefix to find and remove the data.

According to an implementation of the disclosed subject matter, means for attaching data and its lifetime to a relationship between entities may include means that are communicatively coupled to a home security system or smart home system of at least one home for receiving a notification setting for a user for a first entity representing a first home of the at least one home. The implementations may include means for generating a first label for the first home represented by the first entity, and means for storing a relationship between the user and the first entity using the first label. The implementations may include means for storing the notification setting for the user for the first entity by generating a primary key prefix based on a relationship of the user to the first entity, and means for storing the notification setting for the user by associating the notification setting with the primary key prefix. The implementation may include means for receiving a request to delete the relationship to the first entity when the relationship between the user and the first home has ended. The implementation may include means for automatically deleting data at the first entity associated with the relationship of the user to the first home based on the received request using the primary key prefix to find and remove the data.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example method of establishing notification settings for a user that has a relationship with one or more home entities, and automatically deleting data associated with the user when the user's relationship with the home entity ends according to an implementation of the disclosed subject matter.

FIG. 2 shows additional operations of the example method of FIG. 1, where a second entity may be generated, and a relationship between the second entity and the user may be established according to an implementation of the disclosed subject matter.

FIG. 3 shows additional operations of the example methods shown in FIGS. 1-2, where data may be automatically deleted when the user's relationship to one of the entities ends according to an implementation of the disclosed subject matter.

FIG. 4 shows additional operations of the example methods shown in FIGS. 1-3, where notification settings for the user for the home entities may be configured according to an implementation of the disclosed subject matter.

FIG. 5 shows notification settings for a user that has a relationship with a home entity according to an implementation of the disclosed subject matter.

FIG. 6 shows unique labels for each home entity that a user manages, where the labels are retained while the user manages the homes according to an implementation of the disclosed subject matter.

FIG. 7 shows an example sensor according to an implementation of the disclosed subject matter.

FIG. 8 shows a home environment according to an implementation of the disclosed subject matter.

FIG. 9 shows a remote system to aggregate data from multiple locations having security systems according to an implementation of the disclosed subject matter.

FIG. 10 shows an example computing device suitable for implementing embodiments of the presently disclosed subject matter.

### DETAILED DESCRIPTION

Implementations of the disclosed subject matter allows a user to provide settings data, such as notification settings and the like, for a specific home that is controlled by a smart home system and/or home security system. Such systems may include Internet-of-Things (IoT) devices as part of the home network. The settings may be for one or more devices, and the settings may be specific for a particular user who has a relationship with the home (e.g., has been granted access to the home by a manager of the home). That is, the settings may be used when the user is related and/or associated with the home, and may be active while the user's relationship with the home is active. For example, a home manager may provide access to a user of a home between 2-4 PM on weekends, and may allow for user-specific settings for one or more devices of the home during this period (e.g., unlock front door at 2 PM for the user, illuminate an outdoor light of the home for the user when the user is within 10 feet of the front door, or the like). In another example, a user that has a relationship with a home may have a setting to unlock the front door and illuminate a porch light of the home when the user is detected to be within a predetermined distance to the home.

In implementations of the disclosed subject matter, when a relationship is removed (e.g., a user's relationship with the home is deleted by the home manager, the user leaves the home, or the like), the settings associated with the removed relationship are automatically removed from the data of the smart home or home security system. That is, the lifetime of the notification settings data is synchronized to the period of the relationship of the user with the home. This is in contrast to current systems, where data is stored as a custom data type, and the systems do not automatically clear up the data when a relationship between a user and the home changes. Current systems may compromise security of a home by not automatically removing data associated with a user when the user's status with a home changes. That is, in current systems, the user may be a security risk to the home if the user continues to have access to the home after their relationship with the home has ended.

Although complex custom triggers may be written for current systems to perform actions to manage the settings data, such triggers are designed and managed by a user. That is, lapses in management or design flaws may compromise the security and safety of the home with such systems. Moreover, with current systems, it may be unclear as to whether data should be removed at the user device, the security system, and/or another data storage area to remove the user data when the user's relationship with the home has ended. This uncertainty may provide a haphazard system, where the user's access and settings may only be partially removed from the system, or not removed at all, and may cause security issues with a user being able to gain access to a home that the user should no longer be able to access. Implementations of the disclosed subject matter couple access of the home and notification settings to a relationship between the user and the home, where the lifetime of the data and the relationship of the home and the user are synchronized.

Current systems may preserve data associated with a particular device, such a camera of a security system. For example, if the camera is move to a different home, the data captured by the camera when located in the original home may be available to the new home, which may cause security problems for the original home. In contrast, the disclosed subject matter ties data to a relationship (e.g., a user to a home), and removes data when the relationship has ended. That is, the management of data becomes relationship-specific, rather than device-specific.

Implementations of the disclosed subject matter provide systems and methods that provide a storage that allows users to set and/or query against a specific relationship established between the user and the home (e.g., a smart home system and/or a home that includes a security system). When the relationship between the user and the home goes away, such that there is no longer a relationship between the user and the home, the attached data may automatically be removed.

Implementations of the disclosed subject matter may provide systems and methods of configuring distinct notification settings for each home a user and/or home manager has in a corresponding home application (i.e., “home app”) on the user's and/or manager's computing device (e.g., smart phone, tablet, wearable computing device, or the like). A label may be provided to each home in the home app. That is, each home may have a designated home manager, who may set unique labels for each home they manage. The labels may be accurate for as long as the user continues to manage the home (e.g., the smart home network, the home security system, or the like). In the home app, the settings may be removed when a membership ends, the home is deleted, or the user deletes the account. The disclosed subject matter may simplify lookup of a user's settings based on which home they are actively managing.

Implementations of the disclosed subject matter may store relationship data in a table which uses the relationship as a primary key prefix. The entities may be sorted and ordered to generate a primary key prefix. When the system processes a “delete entity” or “delete relationship” request, all relationship data may be automatically deleted by the system that has the determined prefix. When deleting an entity, the system may perform a lookup of one or more relationships and/or all relationships to determine the primary key prefixes. If no relationships are found by the system, there is nothing to delete. In some implementations, the determining of the primary key prefixes, determining the relationships, and deleting any found relationships that match the determined primary key prefix may be executed in a single transaction.

That is, implementations of the disclosed subject matter eliminate the need to design custom solutions for managing notification settings of a smart home system and/or home security system. Users and/or clients do not have to store data in custom data structures, such as maps, on one or more entities (e.g., user entity, home entity, or the like). Rather, data may be stored directly against a relationship between the user and the home. Data that belongs to a relationship may be queried from either entity (e.g., the user or the home). Unlike current systems, the implementations of the disclosed subject matter do not need to do a plurality of calls to perform a lookup of the related entities, and then perform a separate lookup operations for the data for the entities. Implementations of the disclosed subject matter provide automatic cleanup of the data for the notification settings, where a relationship may be deleted and associated data may be correspondingly deleted automatically. That is, the client and/or user does not have to perform any cleanup operations on the notifications setting data when relationships between a user and a home changes.

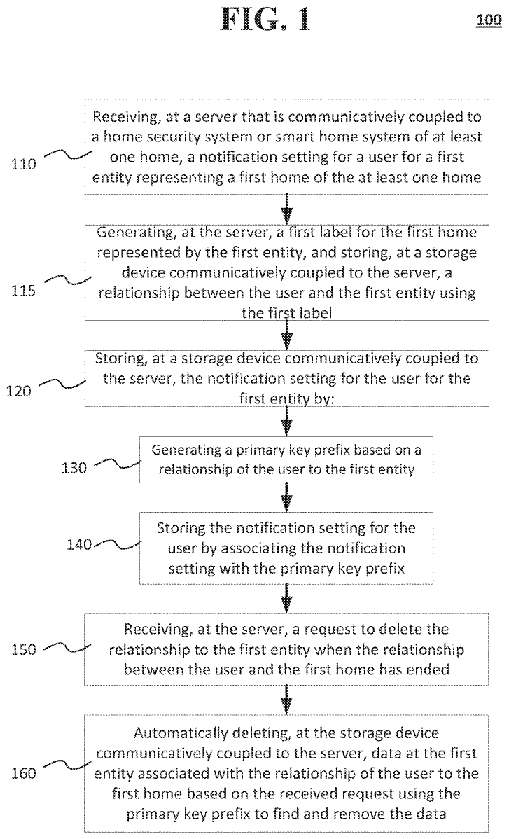

FIG. 1 shows an example method 100 of establishing notification settings for a user that has a relationship with one or more home entities, and automatically deleting data associated with the user when the user's relationship with the home entity ends according to an implementation of the disclosed subject matter. The relationship of the user with the first home may be one of an occupant, a guest, an owner, and/or a resident.

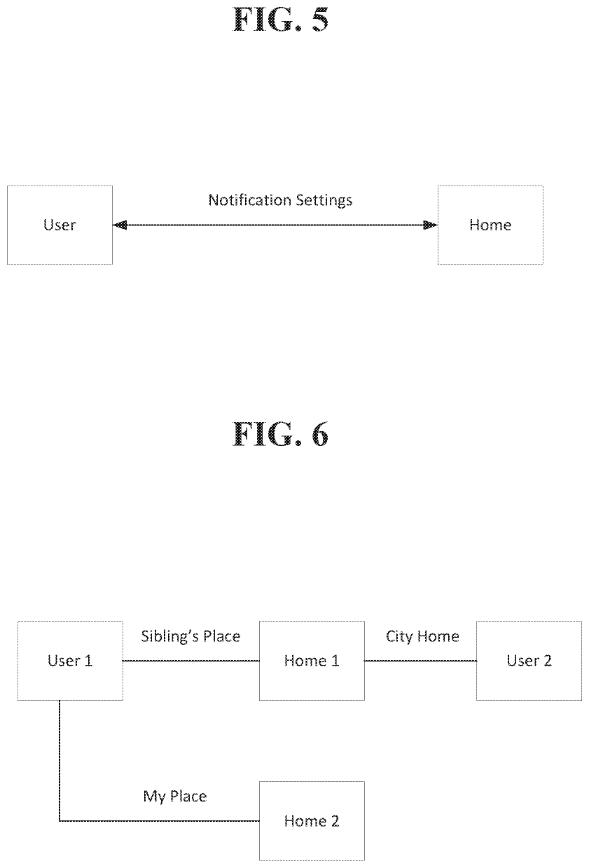

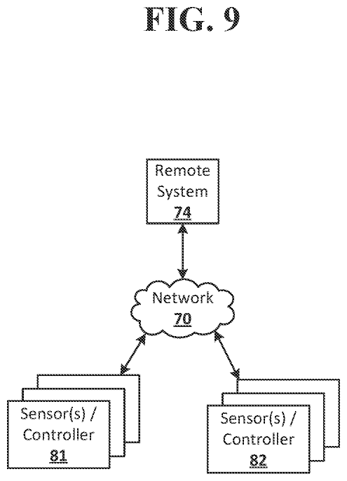

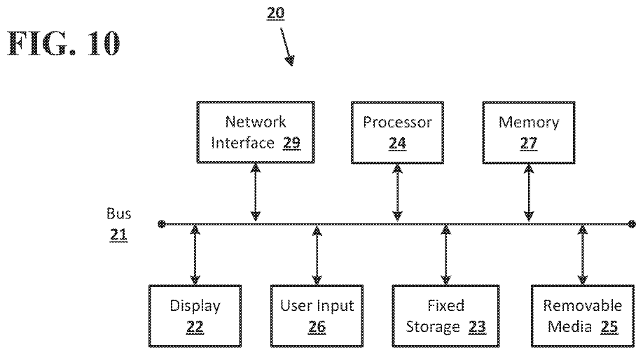

At operation 110, a server (e.g., remote system 74 shown in FIGS. 8-9) that is communicatively coupled to a home security system or smart home system (e.g., controller 73 shown in FIG. 8, and/or controller 81, 82 shown in FIG. 9) of at least one home, may receive a notification setting for a user for a first entity representing a first home of the at least one home. The notification setting may be received by the server from a computing device (e.g., computing device 20 shown in FIGS. 8 and 10). As shown in FIGS. 5-6, notification settings for a user may be for one home and/or for a plurality of homes (e.g., Home 1 and/or Home 2 shown in FIG. 6). The computing device may include an application (i.e., “home app”) that may control and/or communicate with the home security system or smart home system (e.g., controller 73 shown in FIG. 8, and/or controller 81, 82 shown in FIG. 9). The app may allow a user to adjust notification settings for the operation of the home security system such as arming an alarm, setting a delay time before an alarm is armed, setting a mode of operation (e.g., an operation mode when the user is at home, an operation mode when the user is away, an operation mode when the user is on vacation, or the like), adjusting the operation of cameras and/or motion sensors of the security system, and/or or the like. The app may allow the user to adjust notification settings for the HVAC system (Heating Ventilation and Air Conditioning) of the home, and/or allow the user to adjust the lighting operation of the home, or the like.

At operation 115, the server may generate a first label for the first home represented by the first entity, and may store, at a storage device (e.g., database 75 shown in FIG. 8), a relationship between the user and the first entity using the first label. As shown in FIG. 6, Home 1 may be the first home, and may have the first label “Sibling's Place.” In this example, the Home 1 may be owned by the sibling (i.e., brother or sister) of the user, and the user may have a relationship with the home via the sibling.

At operation 120, the storage device may store the notification setting for the user for the first entity. The storage device may be a database (e.g., database 75 shown in FIG. 8), such as a graph database that uses graph structures for semantic queries with nodes, edges, and properties to represent and store data. The graph relates the data items in the store to a collection of nodes and edges, the edges representing the relationships between the nodes (e.g., the relationships between a user and a home). The relationships allow data in the store to be linked together directly and retrieved with one operation.

For example, FIG. 5 shows the stored relationship between a user and a home, with the notification settings for the user associated with the home. The storage operation may include generating a primary key prefix based on a relationship of the user to the first entity at operation 130, and storing the notification setting for the user by associating the notification setting with the primary key prefix at operation 140. In some implementations, the server may sort the identifier (e.g., a unique identifier for a user, a home, and/or a device, and may determine a primary key prefix based on the sorting.

The following may be an illustrative example of storing a user's settings for a device that may be part of the home security system or smart home system using a primary key prefix. In particular, the example may show storing settings for a camera for a user that has a relationship to a home.

In Tables 1-2 below, a User ID may identify the user that has a relationship with a home. The Device ID may identify a device (e.g., a camera) of the home security system and/or smart home system which may be adjusted by the notification settings. Prefix option 1 and Prefix option 2 may be primary key prefixes generated by the server, where one of the prefix options may be selected for the notification setting provided by the user. The selection of the primary key prefix may be made after a sort operation is performed on the prefix options.

A first example of storing a user's settings is shown in Table 1 below:

TABLE 1

| | |
|---|---|
| User ID | jacob57 |
| Device ID | camera03 |
| Prefix option 1 | jacob57.user-to-device.camera03 |
| Prefix option 2 | camera03.device-to-user.jacob57 (WINNER) |

A second example of storing a user's settings for a camera is shown in Table 2 below:

TABLE 2

| | |
|---|---|
| User ID | alex18 |
| Device ID | camera03 |
| Prefix option 1 | alex18.user-to-device.camera03 (WINNER) |
| Prefix option 2 | camera03.device-to-user.alex18 |

In the examples shown in Table 1 and Table 2, the selected primary key prefixes may be chosen (i.e., the “winner”) by the server based on a sort operation (i.e., an alphabetical sort). That is, the server may perform a sort operation, and then select a primary key prefix to be used to store the settings for the camera for the user that has a relationship with the home based on the selected primary key prefix. In Table 1, primary key prefix camera03.device-to-user.jacob57 may be selected by the server, as it falls alphabetically before jacob57.user-to-device.camera03. In Table 2, the primary key prefix alex18.user-to-device.camera03 may be selected by the server because it falls alphabetically before camera03.device-to-user.alex18 in an alphabetical sort. This makes the prefix deterministic for each specific relationship. That is, the prefix may be different for a different user that has a relationship to the same home. A storage device (e.g., database 75 shown in FIG. 8) communicatively coupled to the server may store the notification setting for the user for the first entity, using the selected primary key prefix. That is, the server may associate the notification setting with the primary key prefix, and store the notification setting and the primary key prefix in the storage device.

At operation 150, the server may receive a request to delete the relationship to the first entity when the relationship between the user and the first home has ended. At operation 160, data at the first entity associated with the relationship of the user to the first home based on the received request may be automatically deleted at the storage device communicatively coupled to the server using the primary key prefix to find and remove the data.

That is, notification updates may be in a storage device using a primary key prefix for the relationship between the user and an entity. The entities may be sorted and ordered to generate the primary key prefix. When a request is received by the server to delete the relationship, all relationship data may be automatically deleted by the server that has the determined prefix. When deleting an entity at operation 150, a lookup may be performed to determine relationships using the primary key prefix, and any relationships found using the primary key prefix may be deleted. If no relationships are found by using the primary key prefixes, there is nothing to delete.

For example, a home manager may using a home app executed by the manager's mobile device (e.g., computing device 20 shown in FIG. 10) may select to end a relationship between a user and a home that the manager is managing. The server may use the User ID of the user to be removed to determine the primary key prefixes associated with the user for the home, and may remove the relationship and all data (e.g., settings data for devices of the home) from the storage device that is coupled to the server. That is, any data stored against the relationship between the user and the home may be deleted when the relationship between the user and the home has ended. This differs from current systems, which have to search for data across different devices and/or storage systems, and individually remove specific data items. Such current systems use more computational resources, network resources, and time to remove data than those of the disclosed subject matter. Moreover, such current systems may not delete all data for the user that no longer has a relationship to a home, which may cause security issues as the user may be able to continue to access the home.

Implementations of the disclosed subject matter eliminate the need to design custom solutions for managing notification settings of a smart home system and/or home security system. Users and/or clients do not have to store data in custom data structures, such as maps, on one or more entities (e.g., user entity, home entity, or the like). Rather, data may be stored directly against a relationship between the user and the home. Unlike current systems, the disclosed subject matter does not need to do a plurality of calls to perform a lookup of the related entities, and then perform a separate lookup operations for the data for the entities. The disclosed subject matter provides automatic cleanup of the data for the notification settings, where a relationship may be deleted and associated data may be correspondingly deleted automatically. That is, the user does not have to perform any cleanup operations on the notifications setting data when relationships between a user and a home changes. The automatic cleanup may prevent unauthorized users from accessing a home when they no longer have a relationship with the home. This automatic cleanup may provide enhance security over current systems, which may rely upon a manager of the home security system and/or smart home system to ensure that a user's relationship and access are removed when the user is no longer associated with a home.

Implementations of the disclosed subject matter may provide data “takeout,” where the user may easily download all data to the user's device (e.g., computing device 20 shown in FIG. 10) based on the user's relationship with the home. By using the primary key prefix, the server may retrieve all data from a storage device (e.g., database 75) for a relationship of the user to the home and devices of the home. The implementations of the disclosed subject matter use fewer computational and network resources in obtaining all of the data for the data takeout request, and may provide all of the requested data, unlike current systems which may not be able to locate and provide all of the user's data.

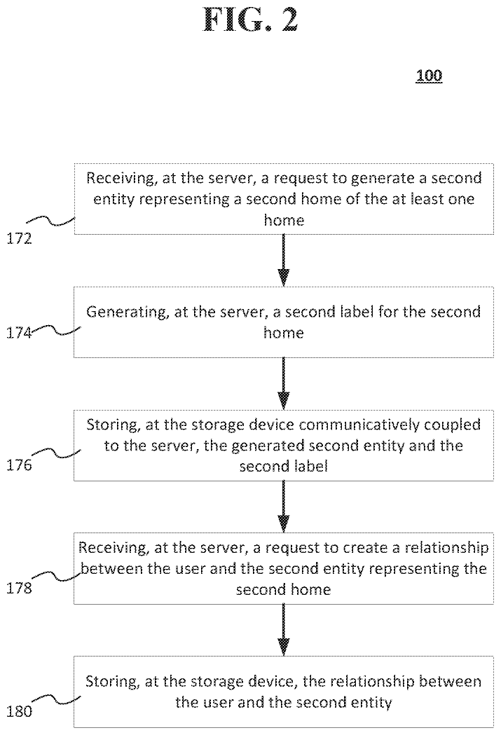

FIG. 2 shows additional operations of the example method of FIG. 1, where a second entity may be generated, and a relationship between the second entity and the user may be established according to an implementation of the disclosed subject matter.

At operation 172, the server may receive a request to generate a second entity representing a second home. At operation 174, the server may generate a second label for the second home. For example, as shown in FIG. 6, Home 2 may be a second entity, and the server may generate the “My Place” label for the second home (i.e., Home 2). At operation 176, the storage device communicatively coupled to the server may store the generated second entity and the second label. For example, the database 75 shown in FIG. 8 may store the generated second labels, and/or entity information for the second home. The generated first labels and first entity information may also be stored in the database 75.

At operation 178, the server may receive a request to create a relationship between the user and the second entity representing the second home. For example, as shown in FIG. 6, a relationship between “User 1” and “Home 2” may be generated based on the received request. At operation 180, the storage device may store the relationship between the user and the second entity. For example, the database 75 shown in FIG. 8 may store the relationship information for generated first and second labels, and/or entity information for the first home and the second home.

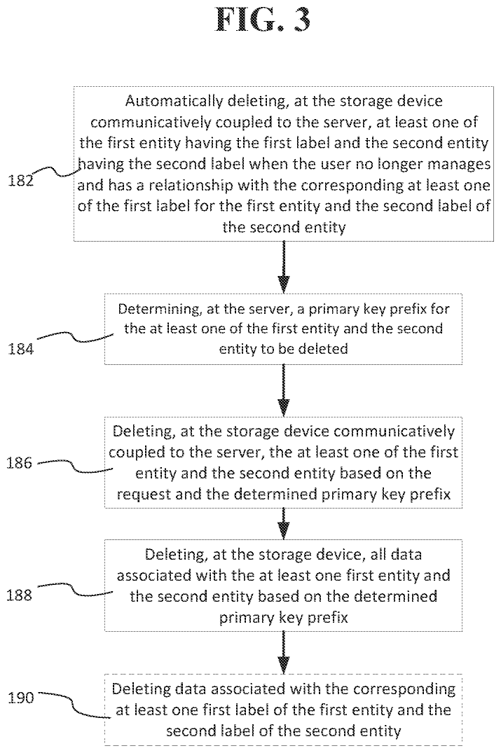

FIG. 3 shows additional operations of the example methods shown in FIGS. 1-2, where data may be automatically deleted when the user's relationship to one of the entities ends according to an implementation of the disclosed subject matter. At operation 182, the first entity having the first label and/or the second entity having the second label may be automatically deleted at the storage device (e.g., database 75 shown in FIG. 8) when the user no longer manages and has a relationship with the corresponding at least one of the first label for the first entity and the second label of the second entity. In the example shown in FIG. 6, the first entity may be Home 1 having the label “Sibling's Place”, and the second entity may be Home 2 having the label “My Place.” That is, the “Sibling's Place” and/or “My Place” labels may be deleted when the user no longer has a relationship with the first entity and/or the second entity.

The operation of automatically deleting may include operation 184, where the server may determine a primary key prefix for the at least one of the first entity and the second entity to be deleted. For example, the server may determine the primary key prefix for the user for Home 1 and/or Home 2 (e.g., as shown in FIG. 6). The first entity and/or the second entity may be deleted at the storage device based on the request and the determined primary key prefix as operation 186. For example, Home 1 (e.g., the first entity) and/or the Home 2 (e.g., the second entity) shown in FIG. 6 may be automatically deleted from the database 75 (shown in FIG. 8) using the determined primary key prefix. All data associated with the at least one first entity and the second entity based on the determined primary key prefix may be deleted at the storage device at operation 188. For example, the data deleted may include the notification settings for the user for the Home 1 and/or Home 2. In some implementations, the automatically deleting may include deleting data associated with the corresponding at least one first label of the first entity and the second label of the second entity at operation 190. For example, as shown in FIG. 6, data may be deleted that is associated with the “Sibling's Place” label of Home 1 and/or the “My Place” label of Home 2.

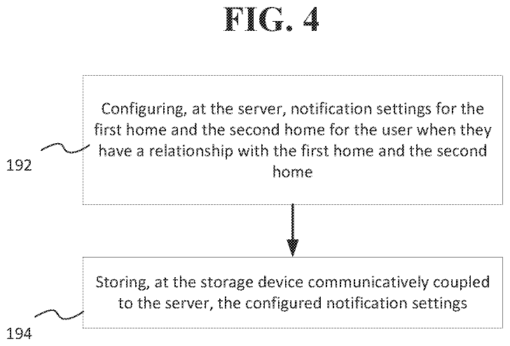

FIG. 4 shows additional operations of the example methods shown in FIGS. 1-3, where notification settings for the user for the home entities may be configured according to an implementation of the disclosed subject matter. At operation 192, notification settings for the first home and the second home for the user may be configured for the user when the user has a relationship with the first home and the second home. For example, as shown in FIG. 6, notification settings may be configured for User 1 for Home 1 and Home 2. At operation 194, the configured notification settings may be stored at the storage device communicatively coupled to the server. For example, the notification settings for User 1 for Home 1 and Home 2 may be stored in the database 75 shown in FIG. 8.

FIG. 5 shows notification settings for a user that has a relationship with a home entity, and FIG. 6 shows unique labels for each home entity that a user manages, where the labels are retained while the user manages the homes according to an implementation of the disclosed subject matter. As shown in FIG. 6, the “Sibling's Place” label may be assigned to Home 1 for User 1, and the “City Home” label may be assigned to Home 1 for User 2. Home 2 may have the label “My Place” assigned to it for User 1.

FIG. 6 shows notification settings for a user that may have a relationship with a home entity according to an implementation of the disclosed subject matter. User 1 may have a relationship with the Home 1, which may be the home of a sibling of the user. That is, User 1 may be a visitor or guest to Home 1. User 1 may also have a relationship with Home 2, which may be the user's home. Notification settings may be configured for User 1 for Home 1 and Home 2. The notification setting may be the same for each home, or may be different for each home. User 2 may have a relationship Home 1, which may be the city home of User 2. Notification settings may be configured for Home 1 for the User 2 that may be the same as or different from the notification settings for Home 1 for User 1. For example, when User 1 loses access to Home 1 (e.g., User 1 is no longer visiting Home 1 of User 1's sibling), the sibling's place label may be automatically deleted by the server when User 1 loses access to Home 1.

In some implementations, the server may provide one or more application programming interfaces (APIs) for the home security system or smart home system. The service APIs may be used to store and/or retrieve data about a relationship between the user and a home, and may be used to store and/or retrieve settings data. For example, the HVAC system, the security system, lighting systems, and/or home settings or the like of the smart home system may use the APIs.

The service APIs provided by the server may be set APIs or query APIs. The set APIs may be used to configure settings notifications for a user, and the query APIs may be used to determine relationships between users and entities. The set APIs are detailed in Table 3 below:

TABLE 3

Set APIs
From Entity
Relationship
To Entity
Value ID
Data

The “To Entity” and “From Entity” APIs may be interchangeable, and may indicate the entity providing the setting notification or the entity receiving the setting notification. The “To Entity” and/or the “From Entity” may be the user, a home, and/or a device. The “Relationship” API may set a relationship of a user to an entity. The “Value ID” API may be an identifier for a value (i.e., of a setting notification) to be set. The “Data API” may associate data to an entity based on relationships between an entity and a user.

The “Query APIs” are detailed in Table 4 below:

TABLE 4

Query APIs
From Entity
Relationship
Value ID
To Entity

For the Query APIs, the “To Entity” and “From Entity” APIs may be interchangeable, and may be used to search the entity providing the setting notification or the entity receiving the setting notification. The “Relationship” API may be used to determine a relationship of a user to an entity. The “Value ID” API may be used identifier for a value (i.e., of a setting notification) to be set. The “Data API” may associate data to an entity based on relationships between an entity and a user.

The systems and methods described throughout may be used for systems other than a home security system and/or a smart home system. For example, the disclosed subject matter may be used in connection with delivery trucks. A relationship may be established between a driver and a truck, rather than between a user and a home. Custom settings for a relationship between a driver and one or more trucks may be stored. If either a truck or driver are removed from a company, then all attached settings may be removed automatically. In another example, the disclosed subject matter may be used to store setting of each player (e.g., of a game) with their respective team. If a player leaves the team or the team is disbanded, then the position data may be automatically deleted.

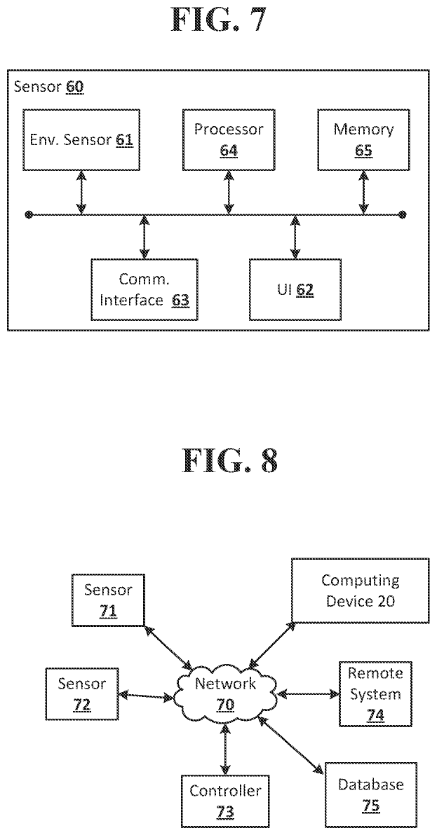

The systems and methods described above in connection with FIGS. 1-6 may be part of a home environment having sensors, as shown and described in connection with FIGS. 7-10. The home environment, which may include the home security system and/or smart home system discussed above with FIGS. 1-6, may use one or more sensors. In general, a “sensor” may refer to any device that can obtain information about its environment. Sensors may be described by the type of information they collect. For example, sensor types as disclosed herein may include motion, smoke, carbon monoxide, proximity, temperature, time, physical orientation, acceleration, location, and the like. A sensor can include, for example, a camera, a retinal camera, and/or a microphone.

A sensor also may be described in terms of the particular physical device that obtains the environmental information. For example, an accelerometer may obtain acceleration information, and thus may be used as a general motion sensor and/or an acceleration sensor. A sensor also may be described in terms of the specific hardware components used to implement the sensor. For example, a temperature sensor may include a thermistor, thermocouple, resistance temperature detector, integrated circuit temperature detector, or combinations thereof. A sensor also may be described in terms of a function or functions the sensor performs within an integrated sensor network, such as a home environment as disclosed herein. For example, a sensor may operate as a security sensor when it is used to determine security events such as unauthorized entry. A sensor may operate with different functions at different times, such as where a motion sensor is used to control lighting in a home environment when an authorized user is present, and is used to alert to unauthorized or unexpected movement when no authorized user is present, or when an alarm system is operating in an away mode, or the like. In some cases, a sensor may operate as multiple sensor types sequentially or concurrently, such as where a temperature sensor is used to detect a change in temperature, as well as the presence of a person or animal. A sensor also may operate in different modes at the same or different times. For example, a sensor may be configured to operate in one mode during the day and another mode at night. As another example, a sensor may operate in different modes based upon a state of a home security system or a home environment, or as otherwise directed by such a system.

In general, a “sensor” as disclosed herein may include multiple sensors or sub-sensors, such as where a position sensor includes both a global positioning sensor (GPS) as well as a wireless network sensor, which provides data that can be correlated with known wireless networks to obtain location information. Multiple sensors may be arranged in a single physical housing, such as where a single device includes movement, temperature, magnetic, and/or other sensors. Such a housing also may be referred to as a sensor or a sensor device. For clarity, sensors are described with respect to the particular functions they perform and/or the particular physical hardware used, when such specification is necessary for understanding of the embodiments disclosed herein.

A sensor may include hardware in addition to the specific physical sensor that obtains information about the environment. FIG. 7 shows an example sensor of the home environment as disclosed herein. The sensor 60 may include an environmental sensor 61, such as a temperature sensor, smoke sensor, carbon monoxide sensor, motion sensor, accelerometer, proximity sensor, passive infrared (PIR) sensor, magnetic field sensor, radio frequency (RF) sensor, light sensor, image sensor, camera, humidity sensor, or any other suitable environmental sensor, that obtains a corresponding type of information about the environment in which the sensor 60 is located. A processor 64 may receive and analyze data obtained by the sensor 61, control operation of other components of the sensor 60, and process communication between the sensor and other devices. The processor 64 may execute instructions stored on a computer-readable memory 65. The memory 65 or another memory in the sensor 60 may also store environmental data obtained by the sensor 61. A communication interface 63, such as a Wi-Fi or other wireless interface, Ethernet or other local network interface, or the like may allow for communication by the sensor 60 with other devices.

A user interface (UI) 62 may provide information (e.g., via a display device or the like) and/or receive input from a user of the sensor. The UI 62 may include, for example, a speaker to output an audible alarm and/or message when an event is detected by the sensor 60, such as an opening of a door or window. Alternatively, or in addition, the UI 62 may include a light to be activated when an event is detected by the sensor 60. The user interface may be relatively minimal, such as a limited-output display, or it may be a full-featured interface such as a touchscreen.

Components within the sensor 60 may transmit and receive information to and from one another via an internal bus or other mechanism. One or more components may be implemented in a single physical arrangement, such as where multiple components are implemented on a single integrated circuit. Sensors as disclosed herein may include other components, and/or may not include all of the illustrative components shown.

FIG. 8 shows an example of a home environment as disclosed herein, which may be implemented over any suitable wired and/or wireless communication networks. One or more sensors 71, 72 may communicate via a local network 70, such as a Wi-Fi or other suitable network, with each other and/or with a controller 73. The controller 73 may include, for example, the hub computing device 100 shown in FIGS. 1-2. The sensors 71, 72 shown in FIG. 8 may represent the sensor 60 shown in FIG. 8 and discussed above. Database 75 may be one or more storage devices which may use any suitable combination of any suitable volatile and non-volatile physical storage mediums, including, for example, hard disk drives, solid state drives, optical media, flash memory, tape drives, registers, and random access memory, or the like, or any combination thereof.

The devices of the home environment of the disclosed subject matter may be communicatively connected via the network 70, which may be a mesh-type network such as Thread, which provides network architecture and/or protocols for devices to communicate with one another. Typical home networks may have a single device point of communications. Such networks may be prone to failure, such that devices of the network cannot communicate with one another when the single device point does not operate normally. The mesh-type network of Thread, which may be used in the security system of the disclosed subject matter, may avoid communication using a single device. That is, in the mesh-type network, such as network 70, there is no single point of communication that may fail so as to prohibit devices coupled to the network from communicating with one another.

The communication and network protocols used by the devices communicatively coupled to the network 70 may provide secure communications, minimize the amount of power used (i.e., be power efficient), and support a wide variety of devices and/or products in a home, such as appliances, access control, climate control, energy management, lighting, safety, and security. For example, the protocols supported by the network and the devices connected thereto may have an open protocol which may carry IPv6 (Internet Protocol version 6) natively.

The Thread network, such as network 70, may be easy to set up and secure to use. The network 70 may use an authentication scheme, AES (Advanced Encryption Standard) encryption, or the like to reduce and/or minimize security holes that exist in other wireless protocols. The Thread network may be scalable to connect devices (e.g., 2, 5, 10, 20a, 20b, 50, 100, 150, 200, or more devices) into a single network supporting multiple hops (e.g., so as to provide communications between devices when one or more nodes of the network is not operating normally). The network 70, which may be a Thread network, may provide security at the network and application layers. One or more devices communicatively coupled to the network 70 (e.g., controller 73, remote system 74, and the like) may store product install codes to ensure only authorized devices can join the network 70. One or more operations and communications of network 70 may use cryptography, such as public-key cryptography.

The devices communicatively coupled to the network 70 of the home environment and/or security system disclosed herein may low power consumption and/or reduced power consumption. That is, devices efficiently communicate to with one another and operate to provide functionality to the user, where the devices may have reduced battery size and increased battery lifetimes over conventional devices. The devices may include sleep modes to increase battery life and reduce power requirements. For example, communications between devices coupled to the network 70 may use the power-efficient IEEE 802.15.4 MAC/PHY protocol. In embodiments of the disclosed subject matter, short messaging between devices on the network 70 may conserve bandwidth and power. The routing protocol of the network 70 may reduce network overhead and latency. The communication interfaces of the devices coupled to the home environment may include wireless system-on-chips to support the low-power, secure, stable, and/or scalable communications network 70.

The controller 73 shown in FIG. 8 that is communicatively coupled to the network 70 may be and/or include a processor. Alternatively, or in addition, the controller 73 may be a general- or special-purpose computer. The controller 73 may, for example, receive, aggregate, and/or analyze environmental information received from the sensors 71, 72. The sensors 71, 72, and the controller 73 may be located locally to one another, such as within a single dwelling, office space, building, room, or the like, or they may be remote from each other, such as where the controller 73 is implemented in a remote system 74 such as a cloud-based reporting and/or analysis system. Alternatively or in addition, sensors 71, 72 may communicate directly with a remote system 74. The remote system 74 may, for example, aggregate data from multiple locations, provide instruction, software updates, and/or aggregated data to a controller 73 and/or sensors 71, 72.

The sensor network shown in FIG. 8 may be an example of a home environment. The depicted home environment may include a structure, a house, office building, garage, mobile home, or the like. The devices of the home environment, such as the sensors 71, 72 and/or camera 75, the controller 73, and the network 70 may be integrated into a home environment that does not include an entire structure, such as an apartment, condominium, or office space.

The home environment can control and/or be coupled to devices outside of the structure. For example, one or more of the sensors 71, 72 may be located outside the structure, for example, at one or more distances from the structure (e.g., sensors 71, 72 may be disposed outside the structure, at points along a land perimeter on which the structure is located, and the like). One or more of the devices in the home environment need not physically be within the structure. For example, the controller 73 which may receive input from the sensors 71, 72 may be located outside of the structure.

The structure of the home environment may include a plurality of rooms, separated at least partly from each other via walls. The walls can include interior walls or exterior walls. Each room can further include a floor and a ceiling. Devices of the home environment, such as the sensors 71, 72 may be mounted on, integrated with and/or supported by a wall, floor, or ceiling of the structure.

The home environment including the sensor network shown in FIG. 8 may include a plurality of devices, including intelligent, multi-sensing, network-connected devices that can integrate seamlessly with each other and/or with a central server or a cloud-computing system (e.g., controller 73 and/or remote system 74) to provide home-security and home environment features. The home environment may include one or more intelligent, multi-sensing, network-connected thermostats (e.g., “network-connected thermostats”), one or more intelligent, network-connected, multi-sensing hazard detection units (e.g., “network-connected hazard detectors”), and one or more intelligent, multi-sensing, network-connected entryway interface devices (e.g., “network-connected doorbells”). The network-connected hazard detectors, network-connected thermostats, and network-connected doorbells may be the sensors 71, 72 shown in FIG. 8.

For example, a network-connected thermostat may detect ambient climate characteristics (e.g., temperature and/or humidity) and may control an HVAC (heating, ventilating, and air conditioning) system accordingly of the structure. For example, the ambient client characteristics may be detected by sensors 71, 72 shown in FIG. 8, and the controller 73 may control the HVAC system (not shown) of the structure.

As another example, a network-connected hazard detector may detect the presence of a hazardous substance or a substance indicative of a hazardous substance (e.g., smoke, fire, or carbon monoxide). For example, smoke, fire, and/or carbon monoxide may be detected by sensors 71, 72 shown in FIG. 8 and the controller 73 may control an alarm system to provide a visual and/or audible alarm to the user of the home environment.

As another example, a network-connected doorbell may control doorbell functionality, detect a person's approach to or departure from a location (e.g., an outer door to the structure), and announce a person's approach or departure from the structure via audible and/or visual message that is output by a speaker and/or a display coupled to, for example, the controller 73.

In some embodiments, the home environment of the sensor network shown in FIG. 8 may include one or more intelligent, multi-sensing, network-connected wall switches (e.g., “network-connected wall switches”), one or more intelligent, multi-sensing, network-connected wall plug interfaces (e.g., “network-connected wall plugs”). The network-connected wall switches and/or network-connected wall plugs may be or include one or more of the sensors 71, 72 shown in FIG. 8. A network-connected wall switch may detect ambient lighting conditions, and control a power and/or dim state of one or more lights. For example, a sensor such as sensors 71, 72, may detect ambient lighting conditions, and a device such as the controller 73 may control the power to one or more lights (not shown) in the home environment. Network-connected wall switches may also control a power state or speed of a fan, such as a ceiling fan. For example, sensors 72, 72 may detect the power and/or speed of a fan, and the controller 73 may adjusting the power and/or speed of the fan, accordingly. Network-connected wall plugs may control supply of power to one or more wall plugs (e.g., such that power is not supplied to the plug if nobody is detected to be within the home environment). For example, one of the network-connected wall plugs may controls supply of power to a lamp (not shown).

In embodiments of the disclosed subject matter, a home environment may include one or more intelligent, multi-sensing, network-connected entry detectors (e.g., “network-connected entry detectors”). The illustrated network-connected entry detectors (e.g., sensors 71, 72 and/or camera 75) may be disposed at one or more windows, doors, and other entry points of the home environment for detecting when a window, door, or other entry point is opened, broken, breached, and/or compromised. The network-connected entry detectors may generate a corresponding signal to be provided to the controller 73 and/or the remote system 74 when a window or door is opened, closed, breached, and/or compromised. According to the operating mode of the security system, the system may output an alarm and/or a notification message (e.g., to a user device, such as a phone, wearable computing device, personal computer, audible message via a speaker, or the like).

The home environment of the sensor network shown in FIG. 8 can include one or more intelligent, multi-sensing, network-connected doorknobs (e.g., “network-connected doorknob”). For example, the sensors 71, 72 may be coupled to a doorknob of a door (e.g., doorknobs 122 located on external doors of the structure of the home environment). However, it should be appreciated that network-connected doorknobs can be provided on external and/or internal doors of the home environment.

The network-connected thermostats, the network-connected hazard detectors, the network-connected doorbells, the network-connected wall switches, the network-connected wall plugs, the network-connected entry detectors, the network-connected doorknobs, the keypads, and other devices of a home environment (e.g., as illustrated as sensors 71, 72 of FIG. 8 can be communicatively coupled to each other via the network 70, and to the controller 73 and/or remote system 74 to provide security, safety, and/or comfort for the home environment).

A user can interact with one or more of the network-connected devices (e.g., via the network 70). For example, a user can communicate with one or more of the network-connected devices using a computer (e.g., a desktop computer, laptop computer, tablet, or the like) or other portable electronic device (e.g., a phone, watch, wearable computing device, a tablet, radio frequency identification (RFID) tags, a key FOB, and the like). A webpage or application can be configured to receive communications from the user and control the one or more of the network-connected devices based on the communications and/or to present information about the device's operation to the user. For example, the user can view can arm or disarm the security system of the home.

One or more users can control one or more of the network-connected devices in the home environment using a network-connected computer or portable electronic device. In some examples, some or all of the users (e.g., individuals who live in the home) can register their mobile device and/or key FOBs with the home environment (e.g., with the controller 73). Such registration can be made at a central server (e.g., the controller 73 and/or the remote system 74) to authenticate the user and/or the electronic device as being associated with the home environment, and to provide permission to the user to use the electronic device to control the network-connected devices and the security system of the home environment. A user can use their registered electronic device to remotely control the network-connected devices and security system of the home environment, such as when the occupant is at work or on vacation. The user may also use their registered electronic device to control the network-connected devices when the user is located inside the home environment.

In some embodiments, the security system may change the mode of operation according to the location of the device (e.g., a phone, wearable computing device, or the like) of the registered user. For example, the system may determine, using GPS data from the user device, that the device is outside of a predetermined range from the home or building, and the system may correspondingly switch the operation mode to an away mode or vacation mode if no other occupants are in the home or building. In some embodiments, the system may transmit a message to the user's registered device (e.g., phone, wearable computing device, or the like) to notify the user of the change in operation mode. Alternatively, or in addition, the system may transmit a request to the user's device, so that the user may confirm or deny the request to change the operating mode of the security system.

Alternatively, or in addition to registering electronic devices, the home environment may make inferences about which individuals live in the home and are therefore users and which electronic devices are associated with those individuals. As such, the home environment may “learn” who is a user (e.g., an authorized user) and permit the electronic devices associated with those individuals to control the network-connected devices of the home environment (e.g., devices communicatively coupled to the network 70), in some embodiments including sensors used by or within the home environment. Various types of notices and other information may be provided to users via messages sent to one or more user electronic devices. For example, the messages can be sent via email, short message service (SMS), multimedia messaging service (MMS), unstructured supplementary service data (USSD), as well as any other type of messaging services and/or communication protocols.

In some embodiments, the security system and/or the home environment may learn (e.g., by aggregating data detected by the sensors over a period of time) the amount of exit time and/or exit patterns of a user. For example, the system may learn which doors of the home a user frequently exits from, what times the doors are used for exit, the patterns of movement in the house by the user prior to exit (e.g., so that the system may change the operating mode to a transition mode, before changing to an away mode when the user has left), the amount of time the user takes to exit the home, or the like. The system may learn to provide the user more time to exit the home if needed, so that an unwanted alarm is not output.

A home environment may include communication with devices outside of the home environment but within a proximate geographical range of the home. For example, the home environment may include an outdoor lighting system (not shown) that communicates information through the communication network 70 or directly to a central server or cloud-computing system (e.g., controller 73 and/or remote system 74) regarding detected movement and/or presence of people, animals, and any other objects and receives back commands for controlling the lighting accordingly.

The controller 73 and/or remote system 74 can control the outdoor lighting system based on information received from the other network-connected devices in the home environment. For example, in the event, any of the network-connected devices, such as wall plugs located outdoors, detect movement at night time, the controller 73 and/or remote system 74 can activate the outdoor lighting system and/or other lights in the home environment.

The one or more sensors 71, 72 may be magnetic field sensors that detect a security event when a door and/or window of a building having the security system disclosed herein has been opened and/or compromised. In yet another example, the one or more sensors 71, 72 may be a smoke sensor and/or a carbon monoxide sensor that detect an environmental event when smoke is sensed and/or carbon monoxide is sensed.

More generally, the sensor 71, 72 may be any sensor capable of obtaining identifying information about a user and/or the environment in which the sensor is disposed, which can be used to determine whether the user is an authorized user by comparison to known information about the user, and to determine information about changes in the environment in which the sensor is disposed.

In embodiments of the disclosed subject matter shown in FIG. 8, the remote system 74 may be a law enforcement provider system, a home security provider system, a medical provider system, and/or a fire department provider system. When a security event and/or environmental event is detected by at least one of one sensors 71, 72 and/or camera 75, a message may be transmitted to the remote system 74. The content of the message may be according to the type of security event and/or environmental event detected by the sensors 71, 72. For example, if smoke is detected by one of the sensors 71, 72, the controller 73 may transmit a message to the remote system 74 associated with a fire department to provide assistance with a smoke and/or fire event (e.g., request fire department response to the smoke and/or fire event). Alternatively, the sensors 71, 72 may generate and transmit the message to the remote system 74. In another example, when one of the sensors 71, 72 detects a security event, such a window or door of a building being compromised, a message may be transmitted to the remote system 74 associated with local law enforcement to provide assistance with the security event (e.g., request a police department response to the security event).

The controller 73 and/or the remote system 74 may include a display to present an operational status message (e.g., a security event, an environmental event, an operational condition, or the like), according to information received from at least one or more the sensors 71, 72 and/or camera 75. For example, the display of the controller 73 and/or remote system 74 may display the operational status message to a user while the user is away from the building having the security system disclosed herein. Alternatively, or in addition, the controller 73 may display the operational status message to a user when the user arrives at and/or departs (i.e., exits) from the building. For example, one or more sensors may identify and authenticate the user, and the security system may display the operational status message.

In some configurations, as illustrated in FIG. 9, a remote system 74 may aggregate data from multiple locations, such as multiple buildings, multi-resident buildings, and individual residences within a neighborhood, multiple neighborhoods, and the like. The remote system 74 may also be a server that hosts the neighborhood network described above in connection with FIGS. 1-6. The neighborhood network may include messaging between, for example two individual neighbors, groups of neighbors, and the like. In general, multiple sensor/controller systems 81, 82 as previously described with respect to FIG. 8 may provide information and/or messages to the remote system 74. The systems 81, 82 may provide data directly from one or more sensors as previously described, or the data may be aggregated and/or analyzed by local controllers such as the controller 73, which then communicates with the remote system 74. The remote system may aggregate and analyze the data from multiple locations, and may provide aggregate results to each location. For example, the remote system 74 may examine larger regions for common sensor data or trends in sensor data, and provide information on the identified commonality or environmental data trends to each local system 81, 82. The remote system 74 may also broadcast, multicast, and/or transmit messages to the systems 81, 82 and/or controller 73.

In situations in which the systems discussed here collect personal information about users, or may make use of personal information, the users may be provided with an opportunity to control whether programs or features collect user information (e.g., a user's current location, a location of the user's house or business, or the like), or to control whether and/or how to receive content from the content server that may be more relevant to the user. In addition, certain data may be treated in one or more ways before it is stored or used, so that personally identifiable information is removed. For example, specific information about a user's residence may be treated so that no personally identifiable information can be determined for the user, or a user's geographic location may be generalized where location information is obtained (such as to a city, ZIP code, or state level), so that a particular location of a user cannot be determined. As another example, systems disclosed herein may allow a user to restrict the information collected by those systems to applications specific to the user, such as by disabling or limiting the extent to which such information is aggregated or used in analysis with other information from other users. Thus, the user may have control over how information is collected about the user and used by a system as disclosed herein.

Embodiments of the presently disclosed subject matter may be implemented in and used with a variety of computing devices. FIG. 10 is an example computing device 20 suitable for implementing embodiments of the presently disclosed subject matter. The device 20 may be used to execute an app that may control the devices of the home environment. Alternatively or in addition, the device 20 may be, for example, a desktop or laptop computer, or a mobile computing device such as a phone, watch, wearable computing device, tablet, or the like. The device 20 may include a bus 21 which interconnects major components of the device 20, such as a central processor 24, a memory 27 such as Random Access Memory (RAM), Read Only Memory (ROM), flash RAM, or the like, a user display 22 such as a display screen and/or lights (e.g., green, yellow, and red lights, such as light emitting diodes (LEDs) to provide the operational status of the security system to the user, as discussed above), a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components 25, 27, which may include RAM, ROM, and other memory, as previously noted. Applications resident with the device 20a, 20b are generally stored on and accessed via a computer readable storage medium.

The fixed storage 23 may be integral with the device 20a, 20b or may be separate and accessed through other interfaces. The network interface 29 may provide a direct connection to a remote server via a wired or wireless connection. The network interface 29 may provide a communications link with the network 70, sensors 71, 72, controller 73, and/or the remote system 74 as illustrated in FIG. 8. The network interface 29 may provide such connection using any suitable technique and protocol as will be readily understood by one of skill in the art, including digital cellular telephone, radio frequency (RF), Wi-Fi, Bluetooth®, Bluetooth Low Energy (BTLE), near-field communications (NFC), and the like. For example, the network interface 29 may allow the device to communicate with other computers via one or more local, wide-area, or other communication networks, as described in further detail herein.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as hard drives, USB (universal serial bus) drives, or any other machine readable storage medium, such that when the computer program code is loaded into and executed by a computer, the computer becomes an apparatus for practicing embodiments of the disclosed subject matter. When implemented on a general-purpose microprocessor, the computer program code may configure the microprocessor to become a special-purpose device, such as by creation of specific logic circuits as specified by the instructions.

Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
receiving, at a server that is communicatively coupled to a home security system or smart home system of at least one home, a notification setting for a user for a first entity representing a first home of the at least one home;
generating, at the server, a first label for the first home represented by the first entity, and storing, at a storage device communicatively coupled to the server, a relationship between the user and the first entity using the first label;
storing, at the storage device, the notification setting for the user for the first entity by:
generating a primary key prefix based on a relationship of the user to the first entity; and
storing the notification setting for the user by associating the notification setting with the primary key prefix; and
receiving, at the server, a request to delete the relationship to the first entity when the relationship between the user and the first home has ended; and
automatically deleting, at the storage device communicatively coupled to the server, data at the first entity associated with the relationship of the user to the first home based on the received request using the primary key prefix to find and remove the data.

2. The method of claim 1, wherein the relationship of the user with the first home is at least one selected from the group consisting of: an occupant, a guest, an owner, and a resident.

3. The method of claim 1, further comprising:
receiving, at the server, a request to generate a second entity representing a second home of the at least one home;
generating, at the server, a second label for the second home;
storing, at the storage device communicatively coupled to the server, the generated second entity and the second label;
receiving, at the server, a request to create a relationship between the user and the second entity representing the second home; and
storing, at the storage device, the relationship between the user and the second entity using the second label.

4. The method of claim 3, further comprising:
automatically deleting, at the storage device communicatively coupled to the server, at least one of the first entity having the first label and the second entity having the second label when the user no longer manages and has a relationship with the corresponding at least one of the first label for the first entity and the second label of the second entity.

5. The method of claim 4, wherein the automatically deleting further comprises:
determining, at the server, a primary key prefix for the at least one of the first entity and the second entity to be deleted;
deleting, at the storage device communicatively coupled to the server, the at least one of the first entity and the second entity based on the request and the determined primary key prefix; and
deleting, at the storage device, all data associated with the at least one first entity and the second entity based on the determined primary key prefix.

6. The method of claim 4, wherein the automatically deleting further comprises:
deleting data associated with the corresponding at least one first label of the first entity and the second label of the second entity.

7. The method of claim 3, further comprising:
configuring, at the server, notification settings for the first home and the second home for the user when the user has a relationship with the first home and the second home; and
storing, at the storage device communicatively coupled to the server, the configured notification settings.

8. A system comprising:
a server, having a hardware processor and a memory, that is communicatively coupled to storage device and to a home security system or smart home system of at least one home to:
receive a notification setting for a user for a first entity representing a first home of the at least one home;
generate a first label for the first home represented by the first entity, and store at the storage device, a relationship between the user and the first entity using the first label;
store, at the storage device, the notification setting for the user for the first entity by generating a primary key prefix based on a relationship of the user to the first entity, and store the notification setting for the user by associating the notification setting with the primary key prefix;
receive a request to delete the relationship to the first entity when the relationship between the user and the first home has ended; and
automatically delete, at the storage device, data at the first entity associated with the relationship of the user to the first home based on the received request using the primary key prefix to find and remove the data.

9. The system of claim 8, wherein the relationship of the user with the first home is at least one selected from the group consisting of: an occupant, a guest, an owner, and a resident.

10. The system of claim 8, wherein the server:
receives a request to generate a second entity representing a second home of the at least one home, generates a second label for the second home;
stores the generated second entity and the second label at the storage device communicatively coupled to the server;
receives a request to create a relationship between the user and the second entity representing the second home; and
stores, at the storage device, the relationship between the user and the second entity.

11. The system of claim 10, wherein the server automatically deletes, at the storage device, at least one of the first entity having the first label and the second entity having the second label when the user no longer manages and has a relationship with the corresponding at least one of the first label for the first entity and the second label of the second entity.

12. The system of claim 11, wherein the server:
determines a primary key prefix for the at least one of the first entity and the second entity to be deleted;
deletes, at the storage device, the at least one of the first entity and the second entity based on the request and the determined primary key prefix; and
deletes, at the storage device, all data associated with the at least one first entity and the second entity based on the determined primary key prefix.

13. The system of claim 11, wherein the server deletes data associated with the corresponding at least one first label of the first entity and the second label of the second entity.

14. The system of claim 10, wherein the server:
configures notification settings for the first home and the second home for the user when the user has a relationship with the first home and the second home; and
stores, at the storage device, the configured notification settings.
